(19) United States
(12) Patent Application Publication
(10) Pub. No.: US 2010/0328579 A1
(43) Pub. Date: Dec. 30, 2010

(54) OPTICAL ELEMENT, AND BACKLIGHT UNIT AND LIQUID CRYSTAL DISPLAY INCLUDING THE SAME

(75) Inventors: Yong-Shig Shim, Seoul (KR); Young-Il Kim, Yongin-si (KR); Sung-Sik Choi, Suwon-si (KR); Byung-Doo Choi, Osan-si (KR)

Correspondence Address: LEXYOUME IP GROUP, PLLC, 5180 PARKSTONE DRIVE, SUITE 175, CHANTILLY, VA, 20151, US

(73) Assignee: LMS CO., LTD., Gunpo-si, Gyeonggi-do (KR)

(21) Appl. No.: 12/520,645

(22) PCT Filed: Apr. 30, 2008
(86) PCT No.: PCT/KR2008/002438

§ 371 Date: Jun. 22, 2009

(30) Foreign Application Priority Data
Feb. 29, 2008 (KR) 10-2008-0019377

(51) Int. Cl. G02F 1/1335; G02B 5/02

(52) U.S. Cl. 349/64; 359/599

(57) ABSTRACT

An optical element capable of improving a light diffusion effect while minimizing a damage of other members in the LCD due to an impact and so on, and a backlight unit and an LCD including the same. The optical element includes an optically-transparent base member; and a light-diffusing resin layer formed on one side of the base member. The light-diffusing resin layer has a plurality of concave recesses formed in a surface thereof to diffuse light. The optical element further includes an optical micro-structural layer formed on the opposite side of the base member. The second light-diffusing resin layer has a plurality of concave recesses formed in a surface thereof to diffuse light.

### TECHNICAL FIELD

The present invention relates to an optical element used in a liquid crystal display (LCD), and more particularly, to an optical element capable of improving a light diffusion effect while minimizing a damage of other members in the LCD due to an impact and so on, and a backlight unit and an LCD including the same.

### BACKGROUND ART

Optical elements, which are widely used in an LCD, may include a light guide plate, a diffusion plate, a prism sheet, a liquid crystal panel and so on. Such optical elements are typically used in the LCD for the purposes of light diffusion, luminance improvement and so on. For example, in the backlight unit used in the LCD, light beams incident from a light source are converted into a surface light source through the light guide plate, are diffused by the diffusion plate, and then enter the prism sheet through its underside surface. Here, the prism sheet can improve the luminance of the LCD by condensing incident light on a light-emitting surface. Such an optical element is adapted to improve a light-diffusing effect by applying a resin layer, in which a number of beads are distributed, to at least one side of a transparent base member.

FIG. 1 is a schematic cross-sectional view illustrating a conventional LCD.

As shown in FIG. 1, the LCD 10 generally includes a backlight unit A and a panel unit B. The backlight unit A includes a light guide plate 12 and a diffusion plate 13, which diffuse and emit light incident from a light source 11. The backlight unit A also includes at least one prism sheet 14 condensing and emitting light incident from the diffusion plate 13, a reflective polarizer film 15 selectively reflecting light incident from the prism sheet 14 and a phase shift layer 16 converting circularly-polarized light, transmitted through the reflective polarizer film 15, into linearly-polarized light. The panel unit B includes an absorptive polarizing film 17, which allows linearly-polarized light and 50% of circularly-polarized light from the backlight unit A to pass through but absorbs the remaining portion of the circularly-polarized light. The panel unit B also includes a liquid crystal panel 18, which visually displays a screen.

FIG. 2 is a schematic sectional view illustrating an optical element used in a conventional LCD.

Referring to FIG. 2, a conventional optical element 20 has a number of beads 22 formed on one or both sides of an optically-transparent base member 21. Preferably, the beads 22 are distributed across a resin layer 23, which is applied to the optically-transparent base member 21. The beads 22 act to diffuse light incident to the base member 21. Such a conventional optical element 20 has problems in that an additional process of forming the light-diffusing beads 22 on the base member 21 is required and costs for purchasing the beads 22 have to be paid.

The conventional optical element 20 has a downwardly-projecting structure (shaped as [symbol] ) defined by the lower portion of the respective bead 22 protruding downward from the underside of the resin layer 23 on the base member 21. In the LCD, the optical element 20 is assembled to and stacked on another optical element. Owing to an impact or negligence, protrusions 24 forming the downwardly-projecting structure of the optical element 20 may damage another optical element, on which the optical element 20 is stacked.

For one example, referring to FIG. 3, when prism sheets 30 and 30′ used as optical elements in an LCD are stacked one atop the other to thereby assemble a backlight unit, protrusions 35 formed with a downwardly-projecting structure [symbol] on the underside of the upper prism sheet 30 come into contact with patterned prisms 36 on the top surface of the lower prism sheet 30′. Here, a vibration test to or awkward delivering or handling of the backlight unit may cause a damage such as a scratch or abrasion to upper edges 37 of the patterned prisms 36 of the lower prism sheet 30′.

For another example, referring to FIG. 4, a backlight unit is assembled by forming a number of beads 33 on the upper side of a diffusion plate 40 acting as an optical element in an LCD and arranging a reversed prism sheet 30″ above the diffusion plate 40. In this case, convex protrusions 35 (shaped as [symbol] ) formed by the beads 33 on the upper side of the lower diffusion plate 40 may contact patterned prisms 36 formed on the underside of the upper reverse prism sheet 30″. Then, a vibration test to or awkward delivering or handling of the backlight unit may cause a damage such as a scratch or abrasion to upper edges 37 of the patterned prisms 36 of the lower reverse prism sheet 30″.

Accordingly, in the art, there has been a demand for the development of an optical element for an LCD, capable of improving a light diffusion effect while preventing other members in the LCD from being damaged by an impact and so on.

### DISCLOSURE

### Technical Problem

The present invention has been made to solve the foregoing problems with the prior art, and embodiments of the present invention provide an optical element, which can improve a light diffusion effect while minimizing a damage (such as scratches etc) of other members due to an impact and so on.

Embodiments of the present invention also provide a backlight unit and a liquid display device (LCD) including the same optical element.

### Technical Solution

In an exemplary embodiment of the present invention, the optical element may include an optically-transparent base member; and a light-diffusing resin layer formed on one side of the base member, wherein the light-diffusing resin layer has a plurality of concave recesses formed in a surface thereof to diffuse light.

In another exemplary embodiment of the present invention, the optical element may include an optically-transparent first base member; a light-diffusing resin layer formed on one side of the base member, wherein the light-diffusing resin layer has a plurality of concave recesses formed in a surface thereof to diffuse light; and a first optical micro-structural layer formed on the opposite side of the base member to condense light.

In a further exemplary embodiment of the present invention, the optical element may include a light-diffusing resin layer having a plurality of concave recesses formed in an underside surface thereof to diffuse incident light; and a liquid crystal panel formed on the light-diffusing resin layer.

In another exemplary embodiment of the present invention, the optical element may include an optically-transparent base substrate, wherein the base substrate has a plurality of concave recesses formed in at least one side thereof to diffuse light.

In an exemplary embodiment of the present invention, the backlight unit may include one of the above-described optical elements.

In another exemplary embodiment of the present invention, the liquid crystal display (LCD) may include the above-described backlight unit.

### ADVANTAGEOUS EFFECTS

The optical element according to an exemplary embodiment of the present invention is applied to an LCD can improve a light diffusion effect while preventing other members from being damaged (such as scratch, abrasion etc) due to an impact and so on, thereby ensuring display qualities.

Furthermore, exemplary embodiments the invention do not require beads to achieve a light-diffusing effect, thereby simplifying a manufacturing process of an optical element, a backlight unit, an LCD and so on and reduce manufacturing costs thereof. Moreover, the size and population of the recesses formed in the surface of the optical element can be adjusted to produce desired values of luminance and haze.

### DESCRIPTION OF DRAWING

The above and other objects, features and other advantages of the present invention will be more clearly understood from the following detailed description taken in conjunction with the accompanying drawings, in which:

FIG. 1 is a schematic sectional view illustrating a conventional LCD;

FIG. 2 is a schematic sectional view illustrating an optical element used in a conventional LCD;

FIG. 3 is a schematic cross-sectional view illustrating a prism sheet used in a conventional LCD;

FIG. 4 is a view illustrating a diffusion plate used in a conventional LCD;

FIG. 5 is a schematic sectional view illustrating an optical element used in an LCD according to a first embodiment of the present invention;

FIG. 6 is a view illustrating simulations about the number and interval of recesses and the resultant haze according to an embodiment of the present invention;

FIG. 7 is an exemplary view illustrating an optical element according to a second embodiment of the present invention;

FIG. 8 illustrates the usage of the optical element according to the second embodiment of the present invention;

FIG. 9 is a schematic sectional view illustrating an optical element according to a third embodiment of the present invention;

FIG. 10 is a schematic sectional view illustrating an optical element according to a fourth embodiment of the present invention; and

FIGS. 11A to 110 are exemplary views illustrating recess structures formed in the surface of optical elements according to embodiments of the present invention.

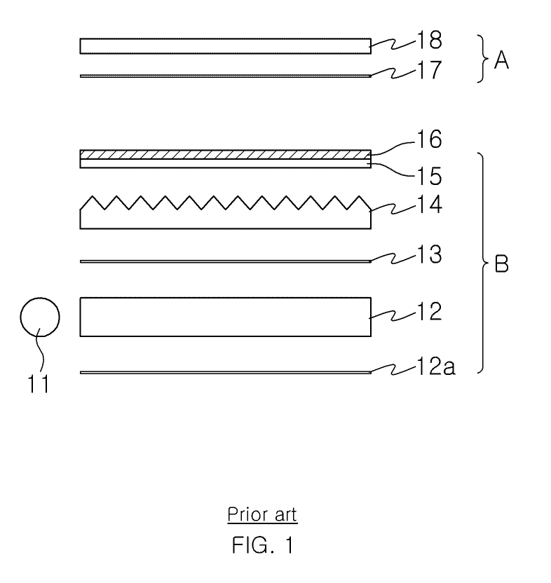

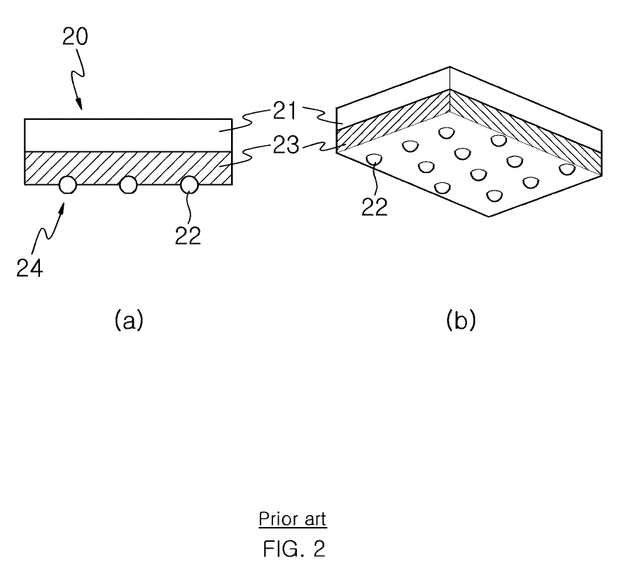

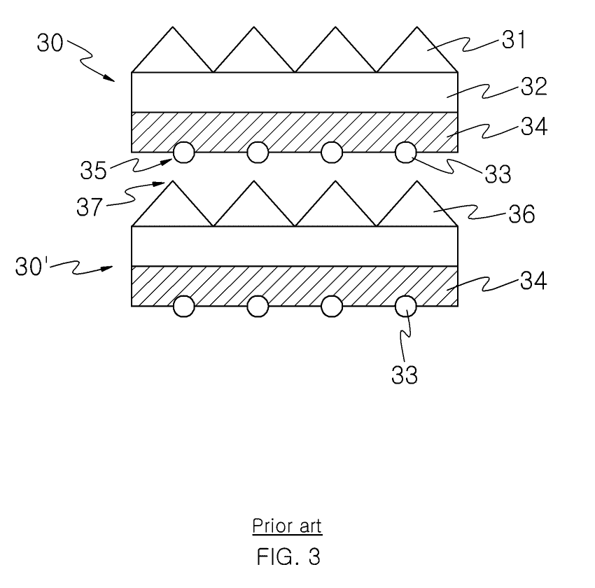

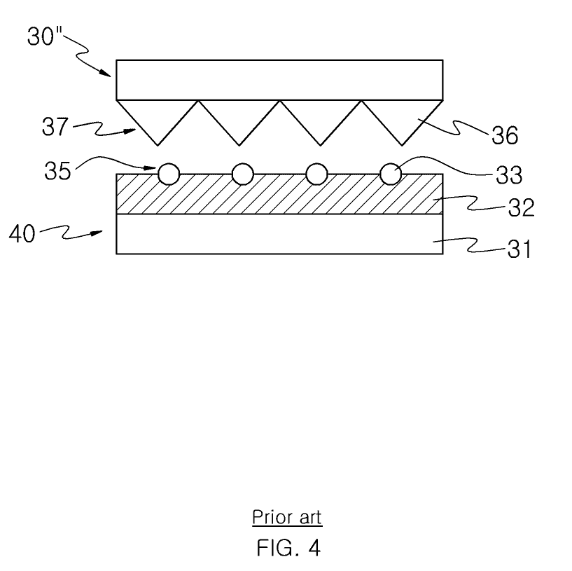

### BEST MODE

Hereinafter, the present invention will be described more fully with reference to the accompanying drawings, in which exemplary embodiments of the present invention are shown. An optical element according to exemplary embodiments of the invention can be widely applied to any structures that are typically used in an LCD. Therefore, the optical element will be provided as an example structure of an element used in the LCD in order to convey the scope of the present invention.

In the following description, well-known functions or constructions by those skilled in the art will not be described in detail when they would obscure the invention in unnecessary detail.

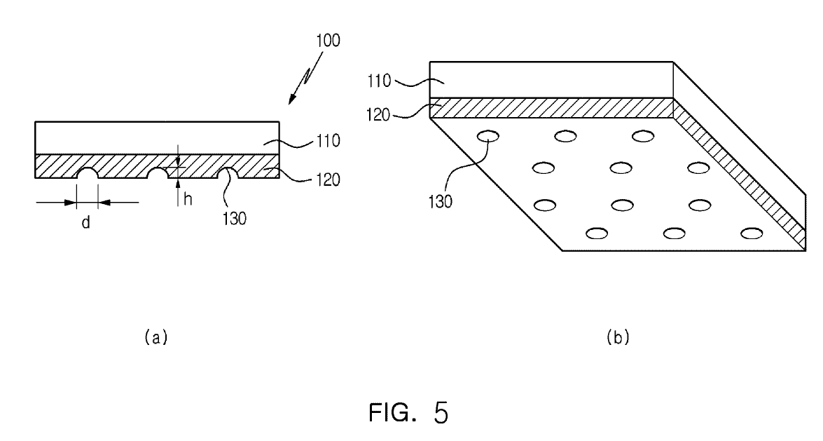

FIG. 5 is schematic sectional views illustrating an optical element used in an LCD according to a first embodiment of the present invention.

Referring to FIG. 5, the optical element 100 according to the first embodiment of the present invention includes an optically-transparent base member 110 and a first light-diffusing resin layer 120 formed on one side of the base member 110. The first light-diffusing resin layer 120 has a plurality of concave recesses 130 (shaped as [symbol] ) formed in one surface thereof.

The base member 110 of the present invention is made of an optically-transparent material capable of transmitting incident light, one example of which is selected from the group consisting of glass, polycarbonate (PC), polyester (PET), polypropylene (PP), polyethylene (PE) and polymethyl methacrylate (PMMA).

The first light-diffusing resin layer 120 has a plurality of the recesses 130 formed in the surface thereof to diffuse incident light. The recesses 130 have a function of diffusing incident light, which is substantially the same as the light-diffusing function of the conventional beads 22 and 33. The optical element 100 of the present invention can diffuse light by the recesses 130 without the beads 22 and 33. The first light-diffusing resin layer 120 is formed by applying a resin layer to one side of the optically-transparent base member 110. The resin layer is made for example of one material selected from the group consisting of acrylic resin, urethane resin, polyethylene resin, polypropylene resin, polystyrene resin and polyamide (nylon) resin.

The optical element 100 according to the first embodiment of the present invention may further include a second light-diffusing resin layer (not shown) formed on the opposite side of the base member 110. The second light-diffusing resin layer (not shown) also can have a plurality of concave recesses (shaped as [symbol] ) formed in one surface thereof. Then the optical element 100 of the present invention may have the first and second light-diffusing resin layers on both sides of the base member 110, each of the light-diffusing resin layers having recesses formed with a concave structure (shaped as [symbol] ) in the surface thereof. In this case, incident light from below is diffused by the recesses of the first light-diffusing resin layer 120, and enters the base member 110. The light, after traveling the base member 110, is diffused again by the recesses of the second light-diffusing resin layer (not shown) before being emitted.

Preferably, as shown in FIG. 5, the first light-diffusing resin layer 120 is provided on the underside of the base member 110, with a plurality of concave recesses 130 formed in the underside surface thereof. In this case, light incident into the base member 110 is diffused by the recesses 130 of the first light-diffusing resin layer 120 before entering the base member 110.

The present invention, however, is not limited to this structure, but the first light-diffusing resin layer 120 can also be formed on the upper side of the base member 110. In other words, the first light-diffusing resin layer 120 can be formed on the upper side of the base member 110, and a plurality of concave recesses 130 formed in the upper surface of the first light-diffusing resin layer 120. In this case, emission light, after traveling the base member 110, is diffused by the recesses 130 of the first light-diffusing resin layer 120 before being emitted.

As such, the optical element 100 according to the first embodiment of the present invention as shown in FIG. 5 can be applied to a backlight unit of an LCD not only with the above-illustrated structure but also with a vertically-symmetric structure.

The optical element 100 according to the first embodiment of the present invention can be used as a diffusion plate or a liquid crystal panel in an LCD. For example, when such an optical element 100 is used as the liquid crystal panel of the LCD, the base member 110 can be made of glass. When the optical element 100 is used as a diffusion plate of a backlight unit, the base member 110 can be made of a polyethylene (PET) film and the like. As such, the optical element 100 used in the LCD can improve light diffusion efficiency by diffusing incident light by the recesses 130.

The recesses 130 formed in the first and second resin layers as above can be arrayed regularly or randomly. Otherwise, some of the recesses 130 can be arrayed regularly while the others are arrayed randomly.

In addition, the width d and the depth h of the respective recess 130 can be adjusted according to the LCD to which the optical element is applied. In this embodiment, it is preferable that the width d is in the range from tam to 30 μm and the depth h is in the range from 1 μm to 30 μm. At the width d of the recess 130 greater than 30 μm, the light-diffusing efficiency significantly decreases to the extent that defects such as white spots can be observed by the eye. The depth h of the recess 130 greater than 30 μm increases the entire thickness so as to be inapplicable in practice.

Further, in this embodiment of the present invention, the interval (distance) between the recesses 130 is preferably in the range from 1 μm to 100 μm, and the haze is preferably in the range from 5% to 40%. The interval and number of the recesses can be adjusted differently according to the haze.

In addition, the recesses 130 have a cross-sectional shape selected from the group a semicircle, a triangle, a quadrangle and a trapezoid. Accordingly, the recesses 130 can be made up of a structure selected from the group consisting of a hemisphere, a polypyramid, a polygon and a polyprism. In the conventional case of coating the beads 22 and 33, the beads have to be manufactured only in a hemispherical shape since only PMMA beads are applicable. According to the present invention, however, the beads can be manufactured in a variety of shapes and thus light diffusion effect can be improved by various methods.

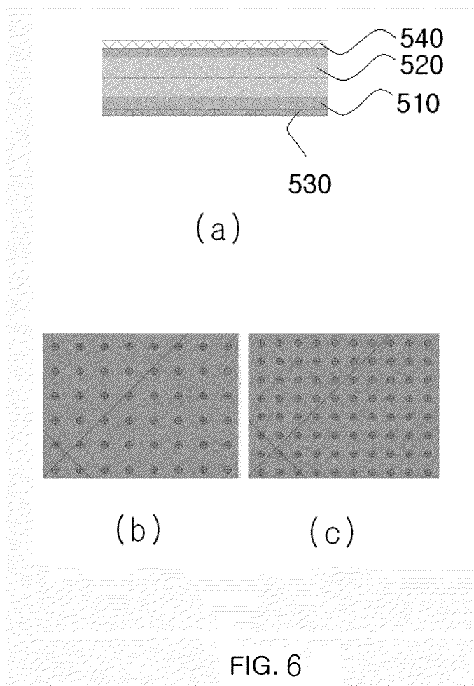

The inventors performed simulation in order to set the range of haze according to the size and interval of the recesses, the results of which are reported in Table 1 below. In the simulation, luminance was measured by forming an optical micro-structural layer 540 (shaped as a prism) on the top surface of a base member 520 and a resin layer 510 having concave recesses 530 on the underside of the base member 520 as shown in FIG. 6(a). Particularly, the luminance was measured by varying the size and interval of the recesses 530. FIG. 6(b) and (c) explain the numbers and intervals of the recesses when the haze is 20% and 40%, respectively.

TABLE 1

| Haze | Max luminance (nit) | Ratio | Average | Ratio |
|---|---|---|---|---|
| 0% | 541.94 | 100% | 403.88 | 100% |
| 5% | 534.65 | 98.65% | 389.73 | 96.49% |
| 20% | 506.71 | 93.49% | 372.30 | 92.18% |
| 40% | 407.28 | 75.15% | 297.07 | 73.55% |
| 60% | 342.25 | 63.15% | 248.46 | 61.51% |

As reported in Table 1 above, a haze below 5% is not effective to scatter or diffuse light. A haze exceeding 40% causes excessively-strong scattering or diffusion, thereby dropping luminance to 70% or less and significantly decreasing a light scattering function. The haze can be further raised to 90% in compensation for poor luminance. The luminance decreases according to the shape recesses, particularly, in the order of a pyramid (corner cube), a cone and a hemisphere. The number and interval of the recesses are determined by the haze, and in the present invention, are adjusted so that the haze is in the range from 5% to 90%. More preferably, the number and interval of the recesses are adjusted so that the haze is in the range from 5% to 40%. Here, the interval of the recesses is preferably in the range from 1 μm to 100 μm.

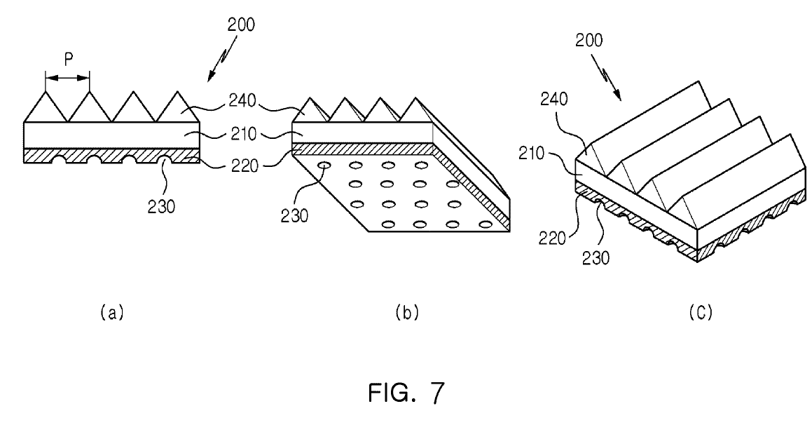

FIG. 7 is an exemplary view illustrating an optical element according to a second embodiment of the present invention.

Referring to FIG. 7, the optical element 200 according to the second embodiment of the present invention includes a first base member 210, a light-diffusing resin layer 220 formed on a first side of the first base member 210 and a first optical micro-structural layer 240 formed on a second side of the first base member 210. The light-diffusing resin layer 220 has a plurality of concave recesses 230 (shaped as [symbol] ) in the surface thereof, and the first optical micro-structural layer 240 condenses and emits light.

The base member 210 of the present invention is made of an optically-transparent material capable of transmitting incident light, one example of which is selected from the group consisting of glass, polycarbonate (PC), polyester (PET), polypropylene (PP), polyethylene (PE) and polymethyl methacrylate (PMMA). When the optical element 200 is used as a diffusion plate of a backlight unit, the base member 210 can be made of a polyethylene (PET) film and the like.

The light-diffusing resin layer 220 has a plurality of the recesses 230 formed in one surface thereof to diffuse incident light. The recesses 230 have a function of diffusing incident light, which is substantially the same as the light-diffusing function of the conventional beads 22 and 33. The light-diffusing resin layer 220 is made for example of one material selected from the group consisting of acrylic resin, urethane resin, polyethylene resin, polypropylene resin, polystyrene resin and polyamide (nylon) resin. The first optical micro-structural layer 240 is formed on the second side opposite the first side of the base member 210 on which the light-diffusing resin layer 220 is formed.

The first optical micro-structural layer 240 is formed with a plurality of patterned micro-structural features, which are arrayed adjacent to each other along one direction of the base member 210. The first optical micro-structural layer 240 serves to condense light to thereby improve luminance across the whole visible surface of an overlying liquid crystal panel (not shown). Each of the patterned micro-structural feature has a cross-sectional shape selected from the group a triangle, an arc and a quadrangle.

Preferably, as shown in FIG. 7, the light-diffusing resin layer 220 is provided on the underside of the first base member 210, with a plurality of concave recesses 230 formed in the underside surface thereof. In this case, light incident into the base member 210 is diffused by the recesses 230 of the first light-diffusing resin layer 220 before entering the base member 210.

The present invention, however, is not limited to this structure, but the first light-diffusing resin layer 220 can be formed on the upper side of the base member 210. In other words, the first light-diffusing resin layer 220 can be formed on the upper side of the base member 210, with a plurality of concave recesses 230 formed in the upper surface thereof. In this case, emission light, after traveling the base member 210, is diffused by the recesses 230 of the light-diffusing resin layer 220 before being emitted.

As such, the optical element 200 according to the first embodiment of the present invention as shown in FIG. 7 can be applied to a backlight unit of an LCD not only with the above-illustrated structure but also with a vertically-symmetric structure.

In addition, the optical element according to the second embodiment of the present invention further includes a second optical micro-structural layer 250 provided under the light-diffusing resin layer 220 and a second optically-transparent base member 260 provided on the underside of the second optical micro-structural layer 250. Here, the second optical micro-structural layer 250 condenses and diffuses incident light to enter the light-diffusing resin layer 220, and the second optically-transparent base member 260 transmits incident light to the second optical micro-structural layer 250.

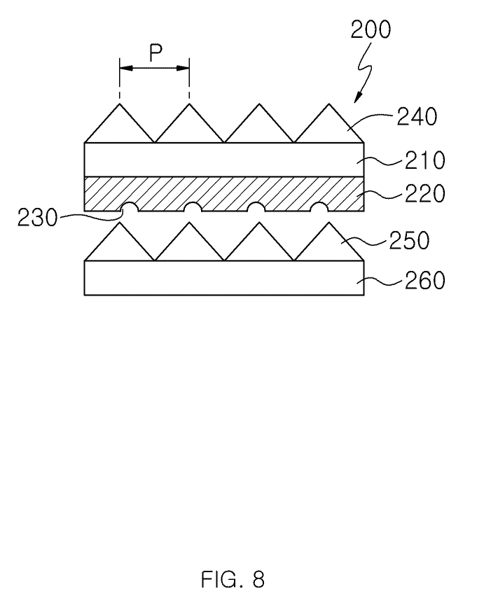

As shown in FIG. 8, the second optical micro-structural layer 250 is provided on the second optically-transparent base member 260, and the light-diffusing resin layer 220, the first optically-transparent base member 210 and the first optical micro-structural layer 240 are sequentially provided above the second micro-structural layer 250. Preferably, each of patterned micro-structural features of the first optical micro-structural layer 240 is oriented perpendicular to patterned micro-structural features of the second optical micro-structural layer 250.

The optical element 200 according to the second embodiment of the present invention can be used as a prism sheet of a backlight unit of an LCD. Here, the base member 210 can be implemented with a PET film. As such, the optical element 200 used for the backlight unit of the LCD can improve light diffusion efficiency by diffusing incident light that enters the base member 210 as well as achieve uniform luminance on the whole area of an overlying liquid crystal panel (not shown) by scattering emission light from the base member 210 by the first optical micro-structural layer 240. Furthermore, a double prism sheet structure in which the two prism sheets are stacked one atop the other can prevent or minimize scratches or abrasion which would otherwise be produced by conventional beads 22 and 33 even if upper edges of the micro-structural features of the second optical micro-structural layer 250 collide against the upper light-diffusing resin layer 220.

The characteristics of the recesses 230 of the optical element 200 according to the second embodiment of the invention are substantially the same as those of the first embodiment, which were previously described, and thus will not be described again. Preferably, the width d of the recesses 230 is smaller than the pitch P of respective micro-structural features of the second light-diffusing micro-structural layer 250.

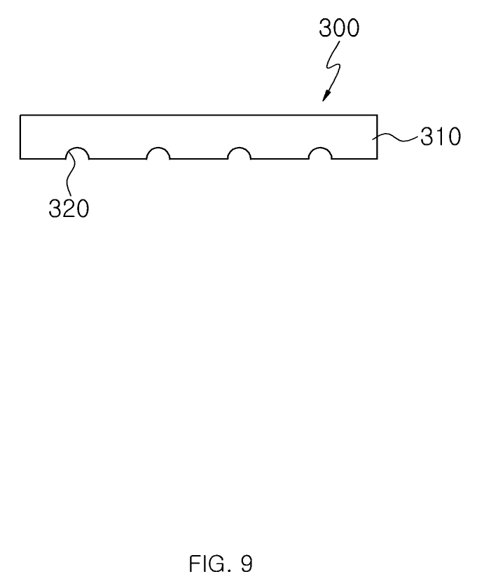

FIG. 9 is a schematic sectional view illustrating an optical element according to a third embodiment of the present invention.

Referring to FIG. 9, the optical element 300 according to the third embodiment of the present invention includes an optically-transparent base member 310, which has a plurality of concave recesses 320 (shaped as [symbol] ) formed in at least one side thereof so as to diffuse light. Unlike the first and second embodiments as described above, in the optical element 300 of this embodiment, the concave recesses 320 are formed directly in the optically-transparent base member 310 so as to diffuse incident light, which enters the base member 310, or emission light, which passes through and exits the base member 310. Here, the recesses 320 serve to diffuse the incident light like the conventional beads 22 and 33. The characteristics of the recesses 320 of the optical element 300 according to the third embodiment of the present invention are substantially the same as those of the first and second embodiments, which were previously-described, and thus will not be described again.

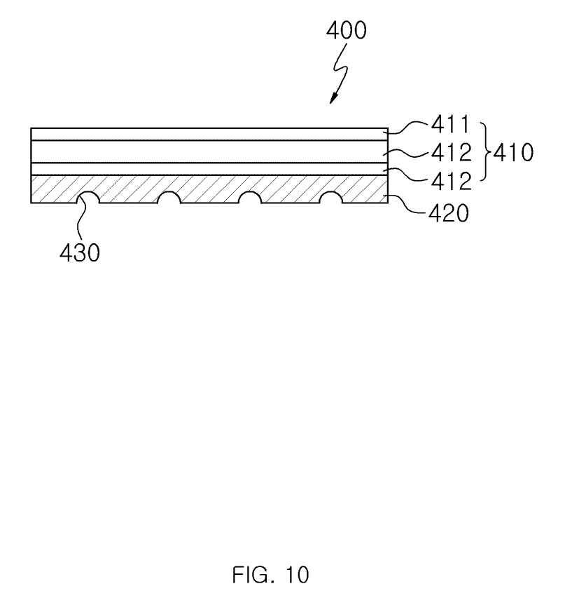

FIG. 10 is a schematic sectional view illustrating an optical element according to a fourth embodiment of the present invention.

Referring to FIG. 10, the optical element 400 according to the fourth embodiment of the present invention includes a light-diffusing resin layer 410, which has a plurality of concave recesses 430 (shaped as [symbol] ) formed in the underside thereof so as to diffuse incident light. Here, the recesses 430 serve to diffuse the incident light like the conventional beads 22 and 33.

In addition, the optical element 400 of the present invention includes a liquid crystal panel 420 formed on the light-diffusing resin layer 410. The liquid crystal panel 420 is formed by injecting liquid crystal between two panels of glass, and is a part of an LCD that visually displays a screen. The liquid crystal panel 420 is known in the art and thus will not be described in detail.

The characteristics of the recesses 430 of the optical element 400 according to the fourth embodiment of the present invention are substantially the same as those of the first to third embodiments, which were previously described, and will not be described again.

The optical element 400 according to the fourth embodiment of the present invention can be used as a liquid crystal panel in an LCD. When the optical element 400 is used as the liquid crystal panel in the LCD, the recesses 430 can diffuse incident light, thereby improving light diffusion efficiency.

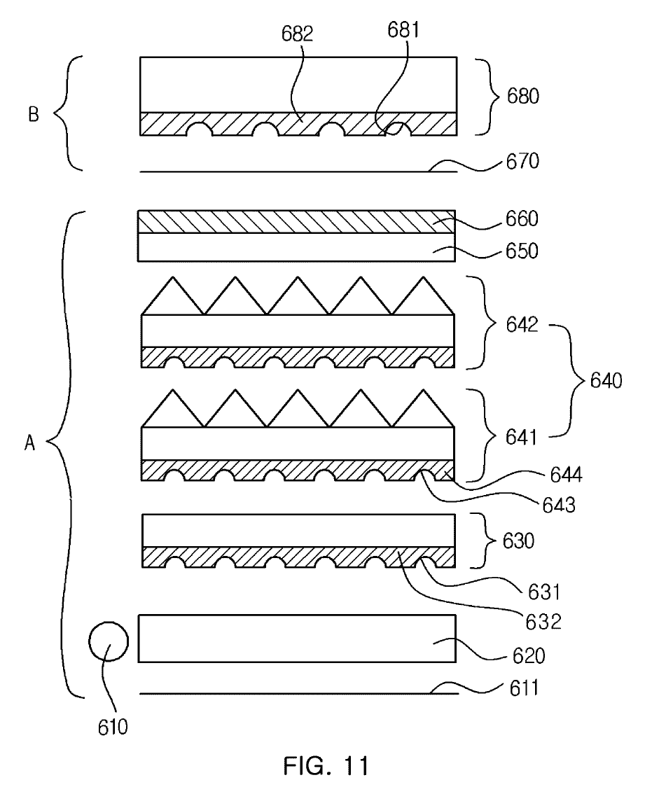

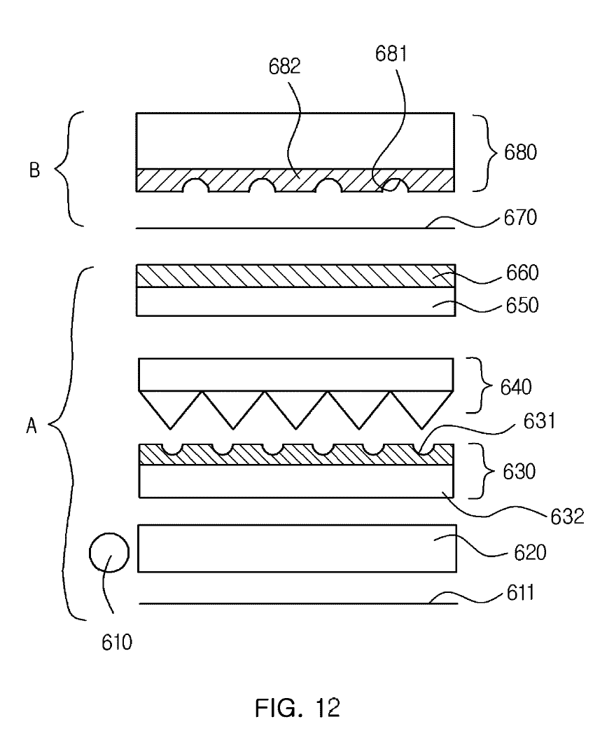

FIGS. 11A to 11C are exemplary views illustrating some portions of LCDs made up of optical elements according to various embodiments of the present invention.

Referring to FIG. 11A, the LCD of the present invention includes a light guide plate 620 and a diffusion plate 630, which diffuse and emit light incident from a light source 610. The backlight unit 600 also includes one or more prism sheets 640 condensing light incident from the diffusion plate 630, a reflective polarizer film 650 selectively reflecting light incident from the prism sheets 640, a phase shift layer 660 converting circularly-polarized light transmitted through the reflective polarizer film 650 into linearly-polarized light, an absorptive polarizing film 670 allowing linearly-polarized light and 50% of circularly-polarized light transmitted through the phase shift layer 660 to pass through but absorbing the remaining portion of the circularly-polarized light and a liquid crystal panel 680 visually displaying a screen.

At least one of the diffusion plate 630, the prism sheets 640 and the liquid crystal panel 680 includes a resin layer 632, 644 or 682, which has a plurality of concave recesses 631, 643 or 681 (shaped as [symbol] ) formed in the underside surface thereof to diffuse incident light. Furthermore, a structure of the prism sheets 640 in which the upper prism sheet 641 is stacked atop the lower prism sheet 642 can prevent or minimize scratches or abrasion which would otherwise be produced by conventional beads 22 and 33 due to vibration or awkward handling even if upper edges of the lower prism sheet 641 comes into contact with the underside surface of the upper prism sheet 642.

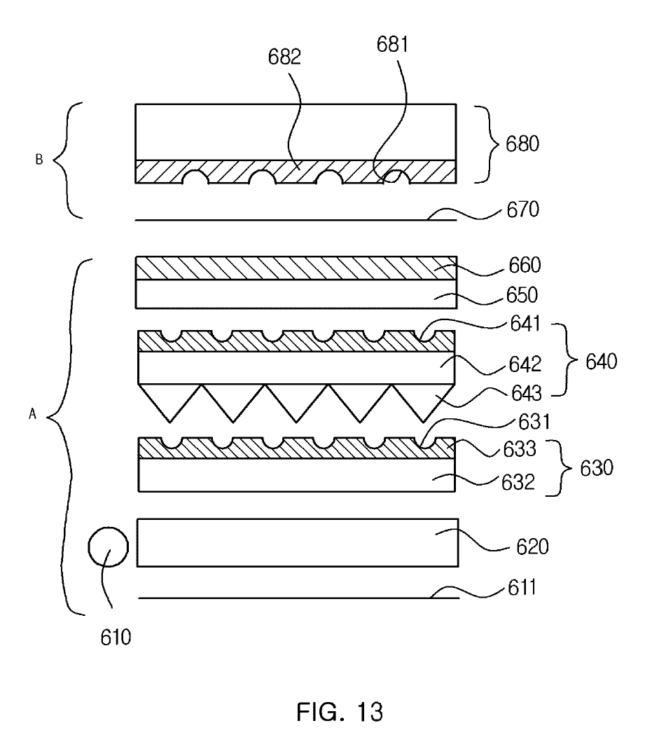

FIGS. 11B and 110 illustrate embodiments in which optical elements 630 and 640 are applied to a backlight unit.

Referring to FIG. 11B, the optical element 630 has a structure in which a light-diffusing resin layer 631 is formed on the upper surface of an optically-transparent base member 632 and an optical micro-structural layer 640 is formed above the light-diffusing resin layer 631. Referring to FIG. 11C, the optical element 640 has a structure in which a first light-diffusing resin layer 641 is formed on the upper surface of an optically-transparent base member 642, an optical micro-structural layer 643 is formed on the underside surface of the optically-transparent base member 642, and a second light-diffusing resin layer 633 is formed under the optical micro-structural layer 643. As such, according to the invention, a variety of configurations of the optical element can be embodied in the backlight unit. In particular, the optical element 630, which comes into contact with the optical micro-structural layer, have the recesses 631 in the contact surface thereof so as to prevent scratches or abrasion of the upper edges of the micro-structural features, which would otherwise be caused by the conventional beads 22 and 33.

The application of the LCD is recently increasing in display devices such as a mobile phone, a TV and a variety of monitors and such trend is expected to continue. Since luminance is a very important factor in the LCD, a variety of optical elements used in the LCD are subjected to technology development for improving luminance and endurance.

In these contexts, the optical element used in the LCD according to the present invention can contribute to quality improvement of final products since it can improve a light diffusion effect while causing a damage minimize to other members by an impact and awkward handling when it comes into contact with the other members. For these reasons, the optical element of the invention will be widely used in display devices.

While the present invention has been illustrated and described in relation to certain embodiments in conjunction with the accompanying drawings, it is to be understood that such embodiments and drawings are illustrative only and that the present invention is in no event to be limited thereto. Rather, modifications and equivalents embodying the principles of the present invention will no doubt occur to those of skill in the art. It is therefore contemplated and intended that the invention shall be defined by the full spirit and scope of the claims appended hereto.

1. An optical element comprising:
an optically-transparent base member; and
a light-diffusing resin layer formed on one side of the base member, the light-diffusing resin layer having a plurality of concave recesses formed in a surface thereof to diffuse light and prevent scratches due to an impact and so on,
wherein the recesses are provided in a predetermined number so that haze ranges from 5% to 90%.

2. The optical element according to claim 1, further comprising a second light-diffusing resin layer formed on the opposite side of the base member, wherein the second light-diffusing resin layer has a plurality of concave recesses formed in a surface thereof to diffuse light.

3-4. (canceled)

5. The optical element according to claim 1, wherein the base member comprises one selected from the group consisting of glass, polycarbonate, polyester, polypropylene, polyethylene and polymethyl methacrylate.

6-7. (canceled)

8. The optical element according to claim 1, wherein the recesses have a predetermined width ranging from 1 μm to 30 μm.

9. The optical element according to claim 1, wherein the recesses have a predetermined depth ranging from 1 μm to 30 μm.

10. The optical element according to claim 1, wherein the recesses have a predetermined the interval (distance) between each other ranging from 1 μm to 100 μm.

11. (canceled)

12. The optical element according to claim 1, wherein the recesses are provided in a predetermined number so that the haze ranges from 5% to 40%.

13. The optical element according to claim 1, wherein the light-diffusing resin layer has a thickness ranging from 1 μm to 20 μm.

14. The optical element according to claim 1, wherein each of the recesses has a cross-sectional shape selected from the group consisting of a semicircle, a triangle, a quadrangle and a trapezoid.

15. An optical element comprising:
an optically-transparent first base member;
a light-diffusing resin layer formed on one side of the base member, the light-diffusing resin layer having a plurality of concave recesses formed in a surface thereof to diffuse light and prevent scratches due to an impact and so on; and
a first optical micro-structural layer formed on the opposite side of the base member to condense light,
wherein the recesses are provided in a predetermined number so that haze ranges from 5% to 90%.

16. (canceled)

17. The optical element according to claim 15, further comprising:
a second optical micro-structural layer formed under the light-diffusing resin layer to condense and emit incident light; and
a second base member underlying the second optical micro-structural layer to transmit incident light to the second optical micro-structural layer.

18. The optical element according to claim 17, wherein the recesses have a predetermined width smaller than a pitch of respective micro-structural features of the second optical micro-structural layer.

19. The optical element according to claim 15, wherein the light-diffusing resin layer is formed on an upper side of the first base member, and has a plurality of the concave recesses formed in an upper surface thereof to diffuse light, which passes through and exits the first base member.

20. The optical element according to claim 19, further comprising:
a second light-diffusing resin layer formed under the first optical micro-structural layer, wherein the second light-diffusing resin layer has a plurality of concave recesses formed in an upper surface thereof to diffuse light; and
a third base member underlying the second light-diffusing resin layer to transmit and emit incident light.

21. The optical element according to claim 20, wherein the second light-diffusing resin layer have a predetermined width smaller than a pitch of respective micro-structural features of the first optical micro-structural layer.

22. The optical element according to claim 15, wherein each of the micro-structural features of the first and second micro-structural layers have a cross-sectional shape selected from the group consisting of a triangle, an arc and a polygon.

23-25. (canceled)

26. The optical element according to claim 15, wherein the recesses have a predetermined width ranging from 1 μm to 30 μm.

27. The optical element according to claim 15, wherein the recesses have a predetermined depth ranging from 1 μm to 30 μm.

28. The optical element according to claim 15, wherein the recesses have a predetermined the interval (distance) between each other ranging from 1 μm to 100 μm.

29. (canceled)

30. The optical element according to claim 15, wherein the recesses are provided in a predetermined number so that haze ranges from 5% to 40%.

31. The optical element according to claim 15, wherein the light-diffusing resin layer has a thickness ranging from 1 μm to 20 μm.

32. The optical element according to claim 15, wherein each of the recesses has a cross-sectional shape selected from the group consisting of a semicircle, a triangle, a quadrangle and a trapezoid.

33. (canceled)

34. An optical element comprising an optically-transparent base substrate,
wherein the base substrate has a plurality of concave recesses formed in at least one side thereof to diffuse light and prevent scratches due to an impact, the recesses being provided in a predetermined number so that haze ranges from 5% to 90%.

35-41. (canceled)

42. A backlight unit comprising an optical element as described in claim 1.

43. A liquid crystal display comprising the backlight unit as described in claim 42.

44. A backlight unit comprising an optical element as described in claim 15.

45. A backlight unit comprising an optical element as described in claim 34.

46. A liquid crystal display comprising the backlight unit as described in claim 44.

47. A liquid crystal display comprising the backlight unit as described in claim 45.
